(19) United States
(12) Patent Application Publication
(10) Pub. No.: US 2007/0206921 A1
(43) Pub. Date: Sep. 6, 2007

(54) Recording Apparatus for Supporting Titling Image, and Method and Control Program for the Same

(75) Inventor: Koichi Machida, Hiroshima (JP)

Correspondence Address: WENDEROTH, LIND & PONACK L.L.P., 2033 K. STREET, NW, SUITE 800, WASHINGTON, DC, 20006, US

(73) Assignee: Matsushita Information Systems Research Laboratory, Hiroshima (JP)

(21) Appl. No.: 10/581,204

(22) PCT Filed: Dec. 14, 2004
(86) PCT No.: PCT/JP04/18980

§ 371 Date: Jun. 1, 2006

(30) Foreign Application Priority Data
Dec. 15, 2003 (JP) 2003-417023

(51) Int. Cl. H04N 5/91

(52) U.S. Cl. 386/95

(57) ABSTRACT

A recording apparatus such as a DVD recorder for supporting titling an image shot by a DV camera or the like, sparing a user the trouble of inputting the title with a remote controller. The DVD recorder prestores information on the schedule of persons who may be objects of shooting, and information concerning general yearly events such as New Year's Day. The DVD recorder retrieves, from the schedule and event information, candidates for the title of the image, based on the shooting time of the image and information concerning a person shot in the image. The DVD recorder then displays the title candidates so that the user can select a desired title from the displayed candidates.

### TECHNICAL FIELD

The present invention relates to titling an image, and specifically to a recording apparatus, method, and control program for supporting titling an image shot by a DV (Digital Video) camera.

### BACKGROUND ART

When users of digital or video cameras take images, the users need to put titles to the images so that they can recognize the contents. In general, camera users put titles to the taken images manually.

Some video cameras provide another method of putting titles in which the video cameras display a list of character sequences that the users can use as the titles of images. More particularly, the video cameras store the character sequences in storage areas thereof as title information and display the list of character sequences in series onto an electronic viewfinder, so that the users can select a character sequence among those displayed on the viewfinder, as the title of an image. This spares the users the trouble of inputting characters as the title.

There is also a technology for automatically putting a title to a moving image when the image is taken by a video camera, based on a schedule stored in the video camera in advance and the time at which the moving image was taken.

The former technology has a problem that it may take a long time before the user selects a character sequence for the title if many character sequences are displayed. This means a loss of time and effort to the user.

The latter technology has a problem that if the schedule does not have any activity scheduled for the date and time at which an image is taken, a title for a scheduled activity that is closest to the date and time is automatically put to the image. This means that images may be titled improperly.

### DISCLOSURE OF THE INVENTION

It is an object of the present invention to provide a recording apparatus that displays appropriate candidates for a title of an image to spare a user the trouble of inputting the title and to prevent an inappropriate title from being put to the image.

This object is fulfilled by a recording apparatus for supporting titling an acquired image and recording the acquired image and a title thereof, comprising: a storage unit prestoring therein title candidates for images and, in correspondence therewith, information concerning time and objects of shooting; a shooting time acquiring unit operable to acquire information of a shooting time of the acquired image; an object information acquiring unit operable to acquire information of an object in the acquired image; a retrieving unit operable to retrieve a title candidate among the prestored title candidates that matches the acquired shooting time information and object information; and a presentation unit operable to present character sequences containing the retrieved title candidate, to a user.

With the above-stated construction, the recording apparatus generates title candidates that are considered to be proper for the acquired image, based on the information concerning the object in the image and the shooting time, and present the title candidates to the user. This reduces the time and effort of the user spent for selecting one from a number of character sequences. This is because the character sequences presented to the user are narrowed down based on certain information concerning the object in the image and the shooting time, and are reduced in amount compared with the conventional technologies.

In the above-described recording apparatus, the storage unit may prestore therein schedule information indicating scheduled activities of persons, together with date/times respectively in correspondence with the scheduled activities, the title candidates are the scheduled activities indicated in the schedule information, the retrieving unit detects a person from the object information acquired by the object information acquiring unit, and retrieves a scheduled activity of the detected person from the prestored schedule information, and the presentation unit presents character sequences containing the retrieved scheduled activity.

With the above-stated construction, if the object in the image is a person, it is possible to present title candidates which are generated based on the schedule of the person by referring to the information concerning the schedule for each user stored in the recording apparatus. This is effective especially in the case of an image that was shot by a home video camera.

The above-described recording apparatus may further comprise a personal information storage unit operable to prestore therein personal information concerning the persons, including indication of sex of the persons, wherein some of the title candidates include names of general yearly events, the storage unit prestores therein information concerning sex and age of objects for general yearly events, each piece of the information corresponding to an event name, the retrieving unit detects a person from the object information acquired by the object information acquiring unit, and reads a piece of personal information corresponding to the detected person, from the personal information storage unit, and retrieves an event name that matches the read piece of personal information, and the presentation unit presents character sequences containing the retrieved event name.

With the above-stated construction, it is possible to select some of general yearly events, such as New Year's Day and Christmas, based on the age of a person who is the object of the image and present the event names as the title candidates.

In the above-described recording apparatus, the personal information storage unit may further prestore therein information concerning age of the persons.

With the above-stated construction, it is possible to narrow down the event names for the title candidates stored in the event information, based on the age of a person who is the object of the image.

In the above-described recording apparatus, the presentation unit may present a list of title candidates in an order of (i) a title candidate being a scheduled activity that matches the acquired shooting time information and object information and (ii) one or more title candidates corresponding to one or more events in an order of a highest to a lowest correspondence level.

With the above-stated construction, it is possible to display title candidates in the order of priority based on the schedule information and the event information. This facilitates the user's search for a desired title.

In the above-described recording apparatus, the presentation unit may present title candidates that contain a name or an age or both the name and age that are extracted from the personal information concerning the object in the acquired image for which the object information acquiring unit has acquired the information.

With the above-stated construction, the user can recognize the name and age at the time of shooting, of the object in the image by reading the title of the image.

The above-described recording apparatus may further comprise: a title determining unit operable to determine the title of the acquired image based on a user input selecting one among the presented character sequences; and an image storage unit operable to store the acquired image and the determined title with indication of a correspondence between thereof.

With the above-stated construction, the recording apparatus can store therein the title determined by the user, together with the image data having the title. This enables the user to recognize the contents of the image by reading the title later.

The above-described recording apparatus may further comprise a still picture attaching unit operable, if the title determining unit determines one among the character sequences containing the retrieved scheduled activity as the title, to extract a still picture from the acquired image and attach the extracted still picture to the schedule information in correspondence with the retrieved scheduled activity.

With the above-stated construction in which one among the character sequences containing the retrieved scheduled activity is determined as the title, the recording apparatus extracts a still picture from the acquired image and attach the extracted still picture to the schedule information in correspondence with the retrieved scheduled activity. This enables the user to recognize whether the scheduled activity was actually performed by checking the presence of a still picture, and also enables the user to recall the performed activity.

### BRIEF DESCRIPTION OF THE DRAWING

FIG. 1 shows an appearance of the DVD (Digital Versatile Disc) recorder, which is the recording apparatus of the present invention, and the peripherals thereof.

FIG. 2 is a functional block diagram of the DVD recorder of the present invention.

FIGS. 3A and 3B show data concerning an image to be titled in relation to the present invention.

FIG. 4A shows an example of the personal information stored in the DVD recorder of the present invention.

FIG. 4B shows an example of the schedule information stored in the DVD recorder of the present invention.

FIG. 5 shows an example of the event information stored in the DVD recorder of the present invention.

FIG. 6 shows an image displayed on the monitor during the title creation process.

FIG. 7 shows an image displayed on the monitor during the title creation process.

FIG. 8 shows an image displayed on the monitor during the title creation process.

FIG. 9 shows an image displayed on the monitor during the title creation process.

FIG. 10 is a sequence diagram showing procedures of the DV camera, DVD recorder, and user.

FIG. 11 is a flowchart showing procedures of the DVD recorder of the present invention in retrieving title candidates.

FIG. 12A shows a picture that was extracted from an image and is to be attached to the schedule information stored in the DVD recorder of the present invention.

FIG. 12B shows schedule information stored in the DVD recorder of the present invention, the schedule information having a picture that is attached thereto after a title based on the schedule information is put to an image.

FIG. 13 is a flowchart showing procedures of the DVD recorder of the present invention in Embodiment 2 in attaching an image to the schedule information.

### BEST MODE FOR CARRYING OUT THE INVENTION

### Embodiment 1

The following describes a DVD recorder for supporting the user to create titles, as an embodiment of the recording apparatus of the present invention, with reference to the attached figures.

1. Construction of DVD Recorder

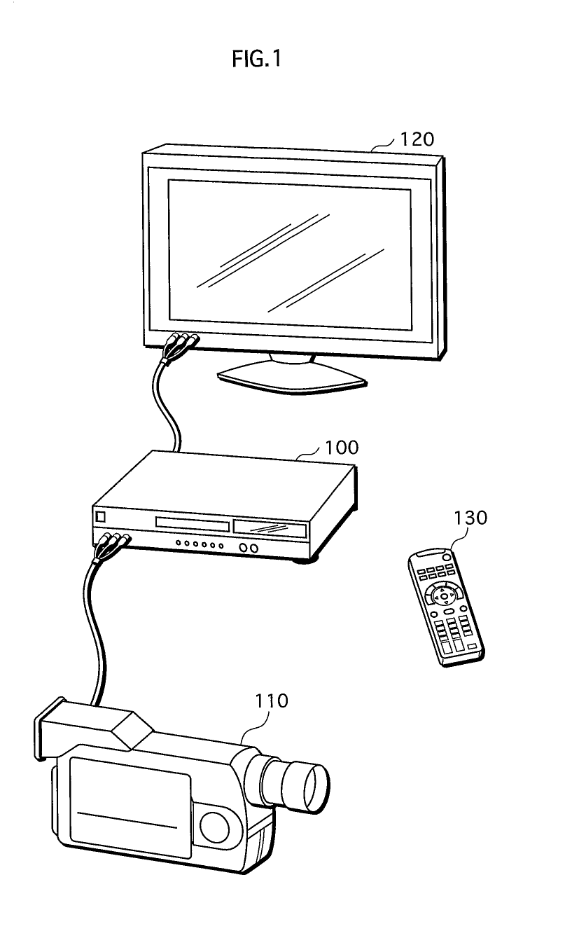

FIG. 1 shows an appearance of the DVD recorder, which is the recording apparatus of the present invention, and the peripherals thereof.

A DVD recorder 100 is connected to a DV camera 110 and a monitor 120 by an AV cable. The DVD recorder 100 has a function to support users to put titles to images. It is presumed here that an image is taken by the DV camera 110, and that the DVD recorder 100 acquires the image from the DV camera 110 and supports a user to put a title to the image, sparing the user the trouble of inputting the title. The monitor 120 provides an easy-to-use, graphical interface to the user. A remote controller 130 is an input apparatus for the user. The user can, for example, determine a title for an image by operating the remote controller 130.

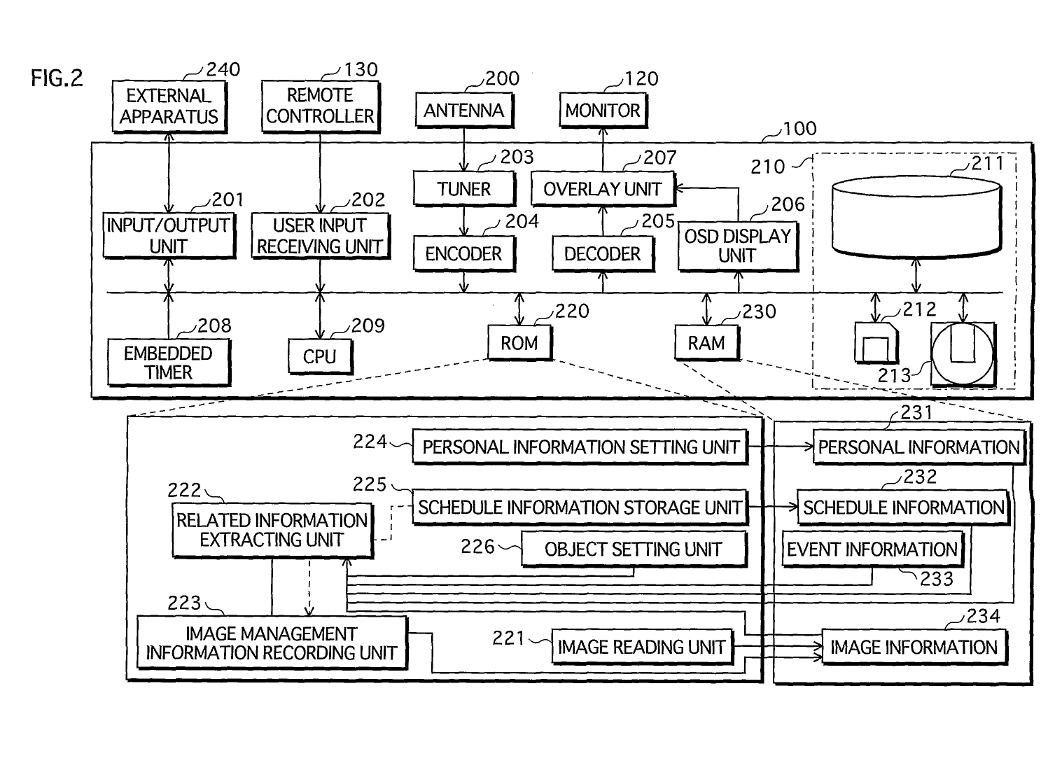

FIG. 2 is a functional block diagram of the DVD recorder 100.

The DVD recorder 100, a recording apparatus, includes an input/output unit 201, a user input receiving unit 202, a tuner 203, an encoder 204, a decoder 205, an OSD display unit 206, an overlay unit 207, an embedded timer 208, a CPU 209, a ROM 220, and a RAM 230.

The input/output unit 201 transfers data with an external apparatus 240. In particular, the input/output unit 201 acquires data related to images from the DV camera 110.

The user input receiving unit 202 receives information input by the user via the remote controller 130, and sends the received information to some of the components of the DVD recorder 100.

The tuner 203 selects a channel for receiving a broadcast wave via an antenna 200, receives video and audio through the selected channel, and sends the received video and audio to the encoder 204.

The encoder 204 encodes the video and audio received from the tuner 203, in accordance with a predetermined encoding format.

The decoder 205 restores image data by decoding data recorded in a recording medium, and outputs the restored image data to the overlay unit 207.

The OSD display unit 206 generates display data indicating the operation settings or status of the recording apparatus.

The overlay unit 207 receives data from the decoder 205 and the OSD display unit 206 and outputs the received data to the monitor 120.

The embedded timer 208 measures local time.

The image to be titled may be acquired from any of recording mediums 210 including a hard disk (HD) 211, a floppy disk (FD) 212, and a DVD 213.

The CPU 209 controls the data transfer performed via a bus, and controls various processes performed in the recording apparatus. The CPU 209 also reads the related information extracting unit 222, which is a program for supporting the title creation in relation to the present invention, from the ROM 220 and executes the related information extracting unit 222.

The ROM 220 stores various programs for controlling the components of the recording apparatus. The ROM 220 also stores programs for supporting the title creation in relation to the present invention. The ROM 220 includes an image reading unit 221, a related information extracting unit 222, an image management information recording unit 223, a personal information setting unit 224, a schedule information storage unit 225, and an object setting unit 226.

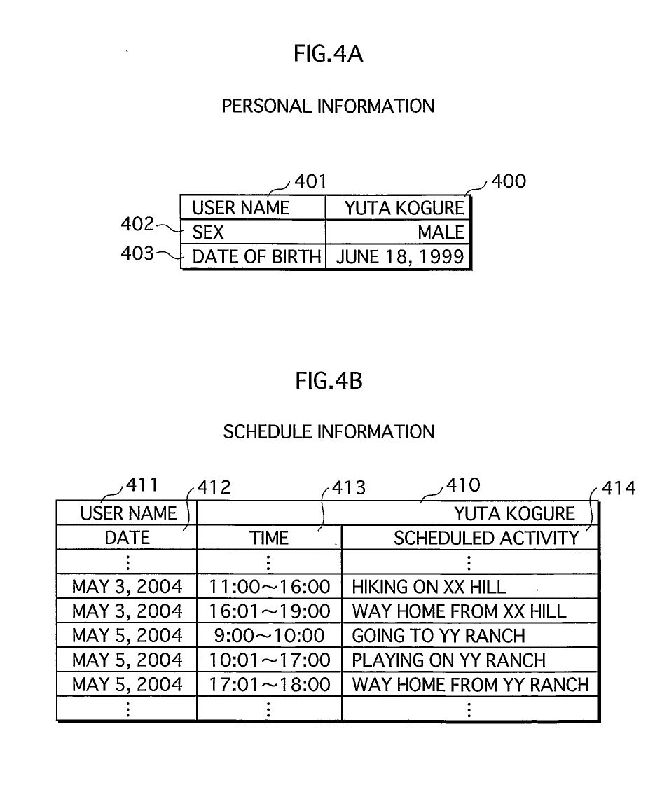

The image reading unit 221 acquires an image from the DV camera 110. The related information extracting unit 222 extracts title-related information from personal information 231, schedule information 232, event information 233, and image information 234, generates candidates for a title from the extracted information, and displays the title candidates on the monitor 120 to the user. The image management information recording unit 223 writes one selected by the user among the candidates into the image information 234 as the title of the image. The personal information setting unit 224 receives personal information input by the user, such as personal information 400 shown in FIG. 4A, via the remote controller 130 or the like, and stores the received personal information into the RAM 230. The schedule information storage unit 225 receives schedule information input by the user, such as the schedule information shown in FIG. 4B, via the remote controller 130 or the like, and stores the received schedule information into the RAM 230 as the schedule information 232. The schedule information storage unit 225 also updates the schedule information. The schedule information 232 may be downloaded from a personal computer or an electronic notebook via the input/output unit 201. The object setting unit 226, during the process of setting the title, receives a user input from the remote controller 130 via the user input receiving unit 202, and sets an object of the image in the title.

The RAM 230 stores a variety of types of data including the personal information 231, the schedule information 232, the event information 233, and the image information 234 that are input by the user. The RAM 230 stores as many pieces of the personal information 231 as there are persons (users) using the DVD recorder 100. Similarly, the RAM 230 stores as many pieces of the schedule information 232 as the number of users of the DVD recorder 100. Each type of stored information will be described in detail later.

2. Data Stored In DVD Recorder

Now, data held by or stored in the DVD recorder 100 will be explained.

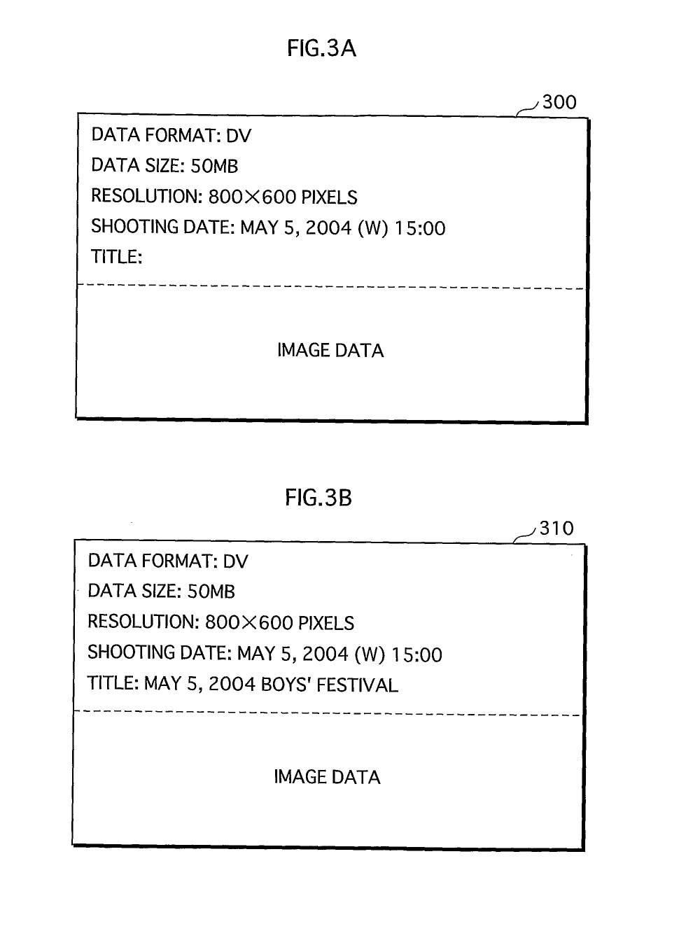

FIGS. 3A and 3B show image data that is received by the DVD recorder 100 from the DV camera 110, and its management information. The management information includes, for each shot image, data format, data size, resolution, shooting date, and title. In the example shown in FIG. 3A, the data format is “DV”, the data size is “50 MB”, the resolution is “800×600”, and the shooting date is “May 5, 2004 (W) 15:00”. FIG. 3A shows data before shooting an image and therefore the data has no title. FIG. 3B shows data after shooting an image and therefore the data has a title of the image.

FIG. 4A shows an example of the personal information 231 stored in the DVD recorder 100. Personal information 400 is information related to a user of the DVD recorder 100. The personal information 400 includes a user name column 401, a sex column 402, and a date of birth column 403. In the example shown in FIG. 4A, the user name column 401 has “Yuta Kogure”, the sex column 402 has “male”, and the date of birth column 403 has “Jun. 18, 1999”. The DVD recorder 100 stores as many pieces of such personal information as there are users thereof.

FIG. 4B shows an example of the schedule information 232 stored in the DVD recorder 100. Schedule information 410 shown in FIG. 4B corresponds to Yuta Kogure shown in the personal information 400.

The schedule information 410 is information concerning schedule of a user of the DVD recorder 100. The schedule information 410 includes a user name column 411, a date column 412, a time column 413, and a scheduled activity column 413, where the scheduled activity written in the scheduled activity column 413 is used as a title candidate, and the date column 412 and the time column 413 indicate the date and the time period during which the corresponding activity is scheduled to be performed. The schedule information 410 is stored in the RAM 230 with indication of correspondence between the columns 411 to 414 for each user. The example shown in FIG. 4B indicates, for example, that a user named Yuta Kogure is scheduled to be playing on YY ranch from 10:01 to 17:00 on May 5, 2004.

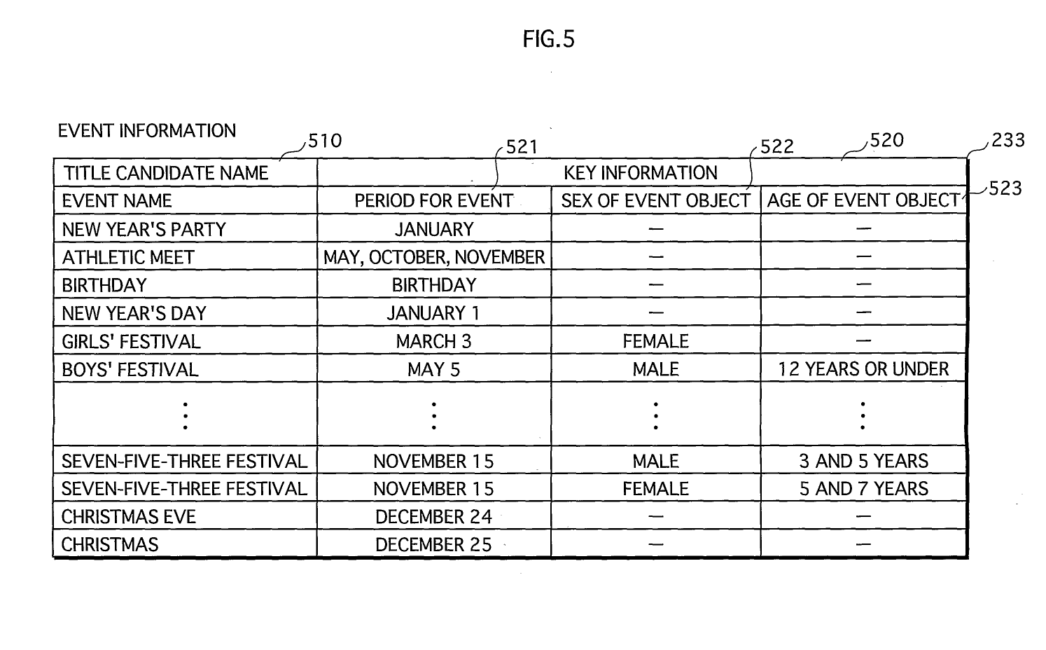

FIG. 5 shows an example of the event information 233 stored in the RAM 230 of the DVD recorder 100. The event information 233 is information on general yearly events, covering all users of the DVD recorder 100. Now, the events shown in the event information 233 of FIG. 5 as an example will be explained briefly.

The new year's party is an event taking place basically in January. The athletic meet is a sports event taking place in spring or autumn, depending on the school or the like. The birthday is a user's birthday. If the shooting date of an image matches the birthday, the event is selected as a candidate for the title of the image. The new year's day is the first day of the year which itself is the target of the celebration. The girl's festival is March 3 on which Japanese people pray for safety and health of girls. The boy's festival is May 5 on which Japanese people pray for safety and health of boys. The seven-five-three festival is November 15 on which Japanese people celebrate the growth of three- and five-year-old boys and three- and seven-year-old girls. Christmas is the birthday of Christ which is celebrated on this day. Christmas Eve is the day before Christmas.

The event information 233 shown in FIG. 5 includes a title candidate name column 510, a key information column 520, an event name column, a period for event column 521, a sex of event object column 522, and an age of event object column 523, where the title candidate name column 510 is composed of the event name column, and the key information column 520 is composed of the period for event column 521, sex of event object column 522, and age of event object column 523. The columns 521 to 523 correspond to each other for each event name. In FIG. 5, boxes with sign “-” indicate that there is no specification in regards with the period or sex or age of the object of the corresponding event. For example, FIG. 5 indicates that the period for the girl's festival is March 3, the sex of its object is female, and there is no specification for the age of its object. The event information 233 is stored in the DVD recorder 100 in advance. The user may add some data to the event information 233 using the remote controller 130 or the like.

3. Operation of DVD Recorder

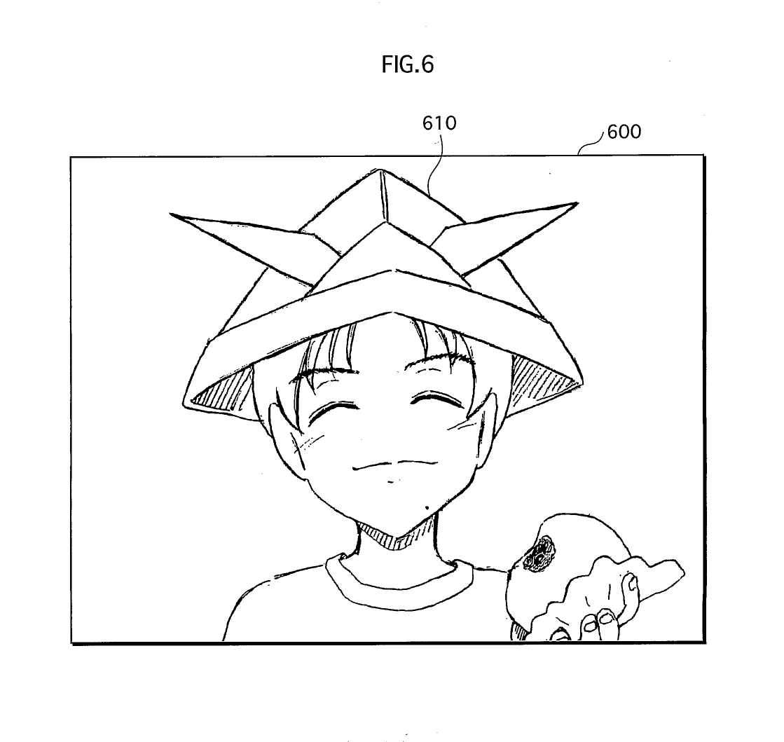

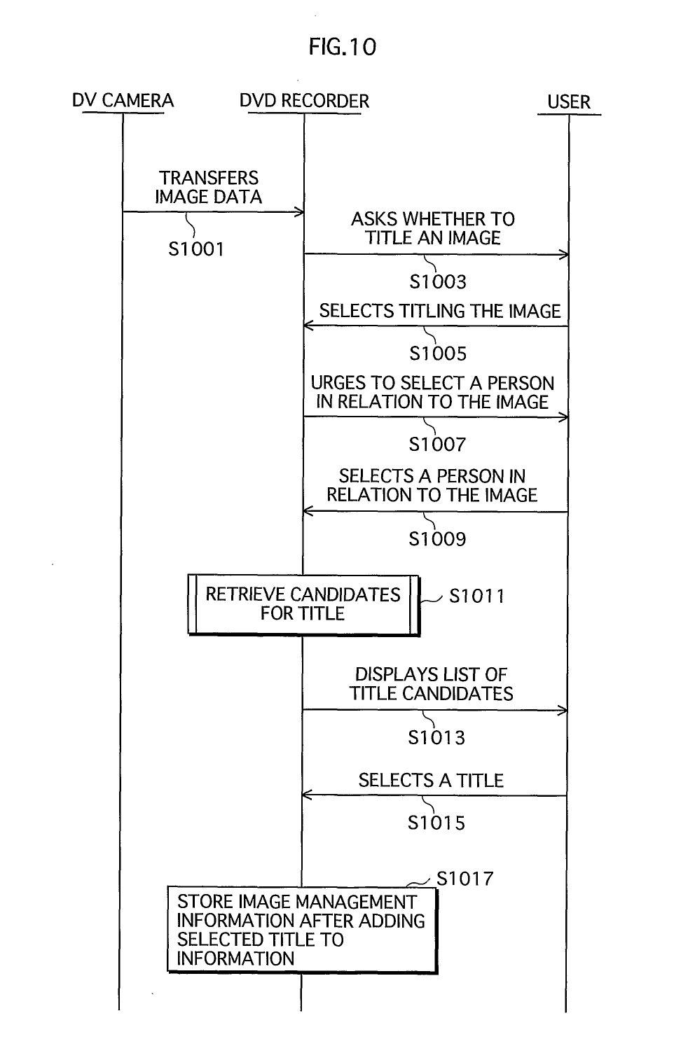

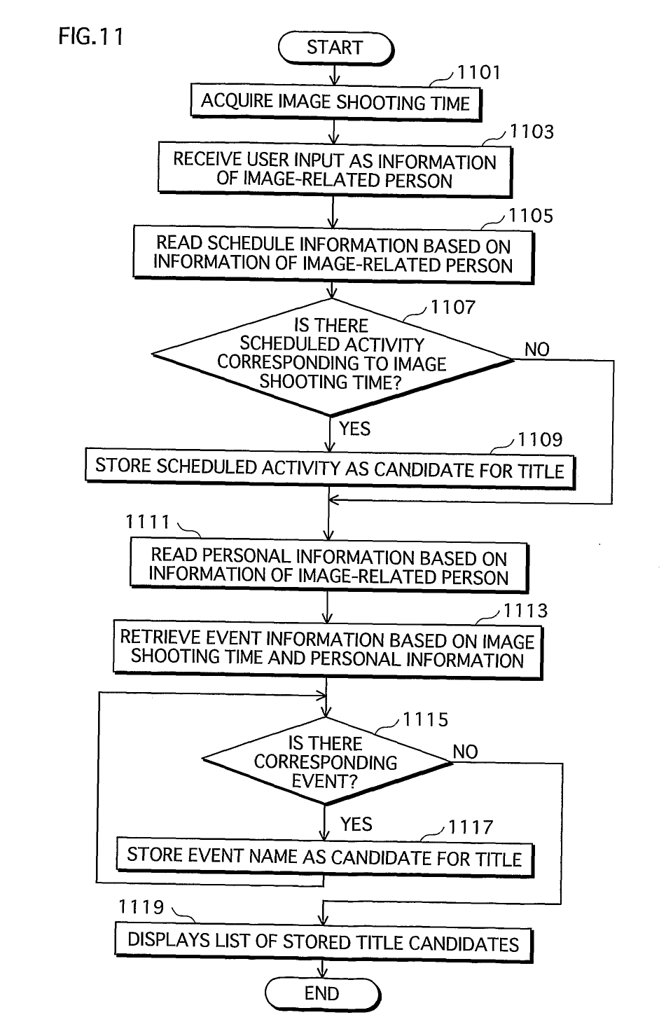

The operation of the DVD recorder 100 for putting a title to an image will be described with reference to FIGS. 6-9 showing screen images displayed on the monitor 120, FIG. 10 showing a sequence diagram, and FIG. 11 showing a flowchart.

First, the data transfer between the DVD recorder 100, the DV camera 110, and the user and the input timing will be described with reference to FIGS. 6-10.

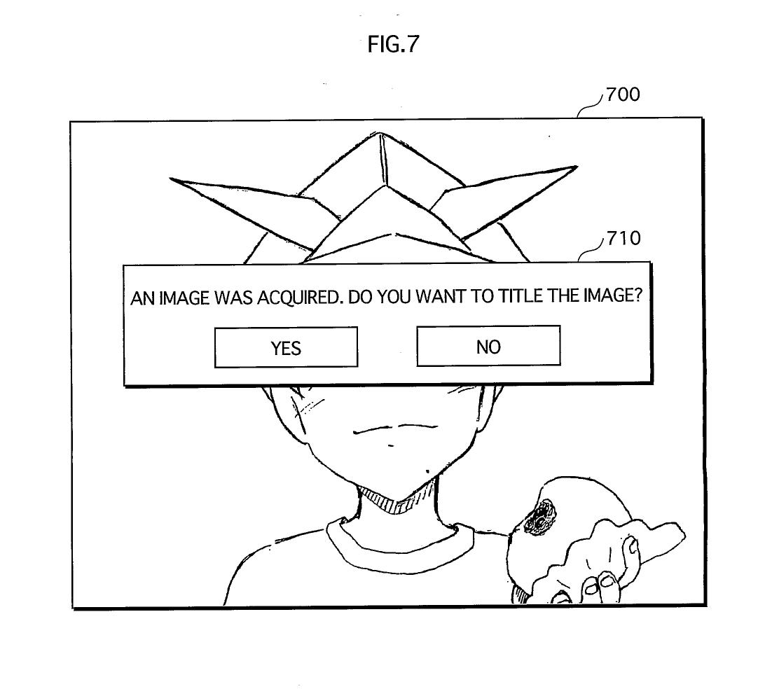

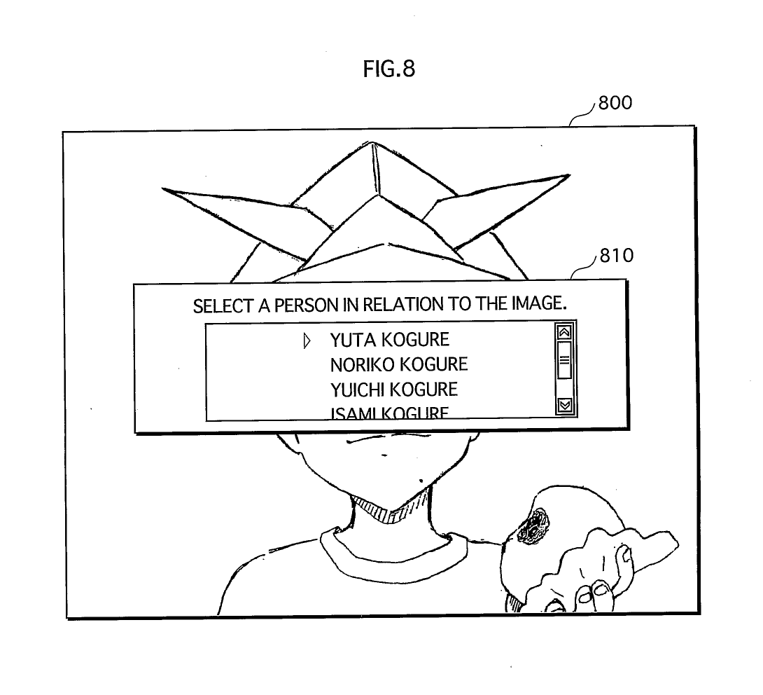

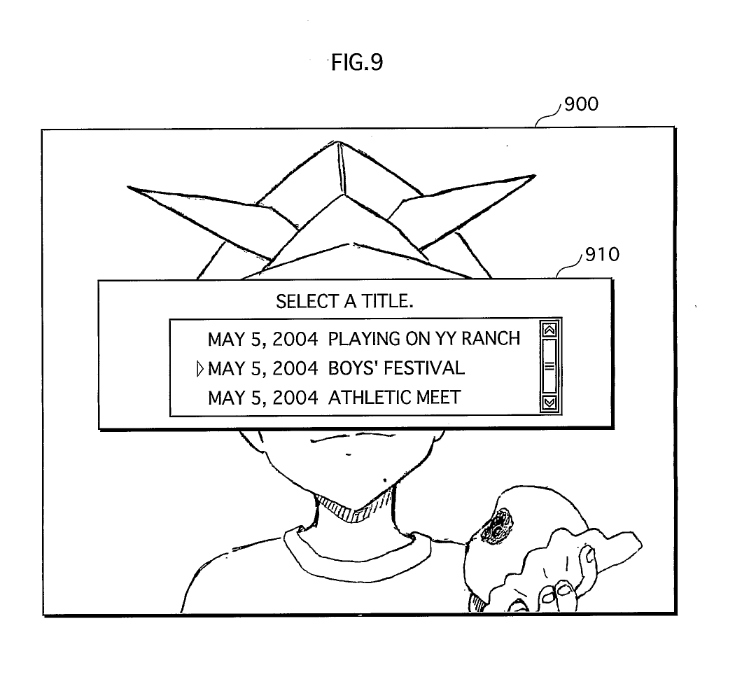

The input/output unit 201 of the DVD recorder 100 receives image data from the DV camera 110 (step S1001). The received image data is stored into the RAM 230. If the received image data has no title, the DVD recorder 100 displays an image of the received image data on the monitor 120 as shown in FIG. 6, then displays a GUI 710 asking the user whether he/she wants to title the image, as shown in FIG. 7 (step S1003). The user sees the image shown in FIG. 7, makes a decision, and enters an input based on the decision using the remote controller 130. In this example, it is presumed that the user decides to title the image (step S1005). It should be noted here that if the user decides not to title the image, the title putting process ends as the user enters an input based on the decision. Upon receiving the input indicating that the user wants to title the image, the DVD recorder 100 displays a GUI 810 urging the user to select a person in relation to the image, as shown in FIG. 8 (step S1007). The user sees the image shown in FIG. 8 and selects a person in relation to the image (step S1009). In this example, it is presumed that the user selects Yuta Kogure as the person related to the image. After receiving the user input, the DVD recorder 100 reads the personal information 400 concerning the selected person Yuta Kogure, retrieves candidates for the title of the image based on the read personal information 400 (step S1011), and displays a list of the retrieved candidates, with a GUI 910 urging the user to select a title, as shown in FIG. 9 (step S1013). How to retrieve the candidates for the title will be described later in detail with reference to FIG. 11. The user selects one among the displayed title candidates as the title of the image (step S1015). In this example, it is supposed that the user selects “May 5, 2004 Playing on YY Ranch”. The DVD recorder 100 stores the image management information after adding the selected title to it (step S1017). The stored image management information in this example is shown in FIG. 3B. By comparison with FIG. 3A, it is understood that the title has been added to the image management information.

Next, the operation of the DVD recorder 100 for retrieving candidates for the title and presenting them to the user will be described with reference to the flowchart shown in FIG. 11.

The image shooting time is acquired (step S1101). The DVD recorder 100 then receives a user input as the information of the image-related person (step S1103). The DVD recorder 100 reads the schedule information 232 based on the information of the image-related person (step S1105). The DVD recorder 100 then reads the shooting date/time of the image, and judges whether there is a scheduled activity that corresponds to the shooting time (step S1107). If it is judged positively in step S1107 (YES in step S1107), the DVD recorder 100 stores the scheduled activity into the RAM 230 as a title candidate (step S1109). If it is judged negatively in step S1107 (NO in step S1107), the DVD recorder 100 reads the personal information 231 from the RAM 230 based on the information of the image-related person (step S1111). The DVD recorder 100 then retrieves the event information based on the image shooting time and the personal information (step S1113), and judges whether there is an event that matches the image shooting time and the personal information (step S1115). If it is judged positively in step S1115 (YES in step S1115), the DVD recorder 100 stores the event name into the RAM 230 as a title candidate (step S1117), and returns to step S1115. If it is judged negatively in step S1115 (NO in step S1115), the DVD recorder 100 reads the candidates for the title from the RAM 230, and displays the read title candidates as a list (step S1119). This completes the title candidate presentation process.

The title candidate presentation and title putting processes will be described in more detail with a specific example. In this example, it is presumed that on May 5, 2004 (Japanese holiday celebrating the boy's festival), the family of the user had planned to go to the YY ranch to play there, but for some reason stayed at home and shot the image of his/her son Yuta Kogure celebrating the boy's festival. FIG. 6 shows the image taken in the house of the Kogure family. In this example, the user is going to put a title to the image.

The DVD recorder 100 acquires an image from the DV camera 110 connected thereto, via the monitor 120. After detecting that the image was acquired, the DVD recorder 100 checks to see if the image management information has the title of the image. If the image management information has no title for the image, the DVD recorder 100 displays a scene of the image shown in FIG. 6 on the monitor 120 so that the user can recognize the contents of the image. The DVD recorder 100 then asks the user whether he/she wants to title the image, as shown in FIG. 7. The user sees the image shown in FIG. 7, makes a decision using the selection and enter keys (not illustrated) provided on the remote controller 130. In this example, it is presumed that the user decides to title the image. Upon receiving the input indicating that the user wants to title the image, the DVD recorder 100 displays a GUI 810 as shown in FIG. 8 urging the user to select a person in relation to the image among a list of persons also displayed on the screen. Here, the displayed list of persons is generated by extracting user names from the personal information 231 stored in the DVD recorder 100. Since the DVD recorder 100 is owned by the Kogure family, the list contains the names of the family members. The user selects a person among the displayed names of persons. It is presumed here that the user selects Yuta Kogure who is the main character of the shot image. After receiving the user input indicating that Yuta Kogure was selected, the DVD recorder 100 reads the personal information 400 stored therein in relation to Yuta Kogure, and reads the schedule information 410 corresponding to Yuta Kogure. The DVD recorder 100 compares the shooting date/time of the image with the schedule information 410 to detect an activity scheduled for the shooting time of the image. In this example, the shooting time is 15:00 on May 5, 2004, as shown in FIG. 3A. Accordingly, the DVD recorder 100 extracts “Playing on YY Ranch” that is a scheduled activity corresponding to the shooting time, from the 410, and stores “May 5, 2004 Playing on YY Ranch” into the RAM 230 as a candidate for the title of the image.

The DVD recorder 100 then detects from the personal information 400 that Yuta Kogure is male, and that Yuta Kogure is five years old at the time the image was shot, by subtracting the date of birth from the shooting date/time. The DVD recorder 100 searches the event information 233 based on the detected information. In this example, the DVD recorder 100 retrieves events for which the sex of event object is set to male and events for which the sex of event object is not specified. The DVD recorder 100 retrieves events for which the age of event object is set to five years old. The DVD recorder 100 stores the retrieved events into the RAM 230 in the order of the retrieval. For example, “May 5, 2004 Boy's Festival” and “May 5, 2004 Athletic Meet” are retrieved from the event information 233 and stored into the RAM 230. After completing the search of the event information 233 for the retrieval, the DVD recorder 100 displays a list of candidates for the title on the monitor 120, as the GUI 910 shown in FIG. 9. The candidates for the title are displayed, from top down, in the order of the candidates generated from the 410 and the candidates generated from the event information 233. A plurality of candidates for the title generated from the event information 233 are displayed in the order of highest to lowest in the number of retrieval keys, such as the age, sex, and date, that match the personal information of the object. Also, a plurality of candidates that match the personal information in terms of the event period are displayed in the order of shortest to longest in the event period shown in the period for event column 521. In this example, “Athletic Meet” matches only in terms of the period for event column 521, while “Boy's Festival” matches in terms of the period for event column 521, sex of event object column 522, and age of event object column 523. As a result, “Boy's Festival” is displayed in precedence to “Athletic Meet”, at a higher position on the screen. The user selects a title, which the user considers most appropriate, among the displayed list of candidates for the title. In this example, the user selects “May 5, 2004 Boy's Festival”. The DVD recorder 100 attaches the selected title to the image data, and records the image data together with the title. This completes the title putting process.

### Embodiment 2

The following describes a DVD recorder for supporting the user to create titles, as the second embodiment of the recording apparatus of the present invention, with reference to the attached figures.

Embodiment 2 relates to a case where the title is selected among candidates that are generated based on the schedule information 232 in Embodiment 1. If the DVD recorder 100 acquires from the DV camera 110 an image whose title was generated based on the schedule information 232 and includes a scheduled activity shown in the schedule information 232, the DVD recorder 100 extracts a still picture from the received image and attaches the still picture to the schedule information 232. Embodiment 2 requires the same construction of the DVD recorder 100 as Embodiment 1.

4. Data Stored In DVD Recorder

In Embodiment 2, it is presumed that Yuta Kogure played on YY ranch on May 5, 2004, different from Embodiment 1.

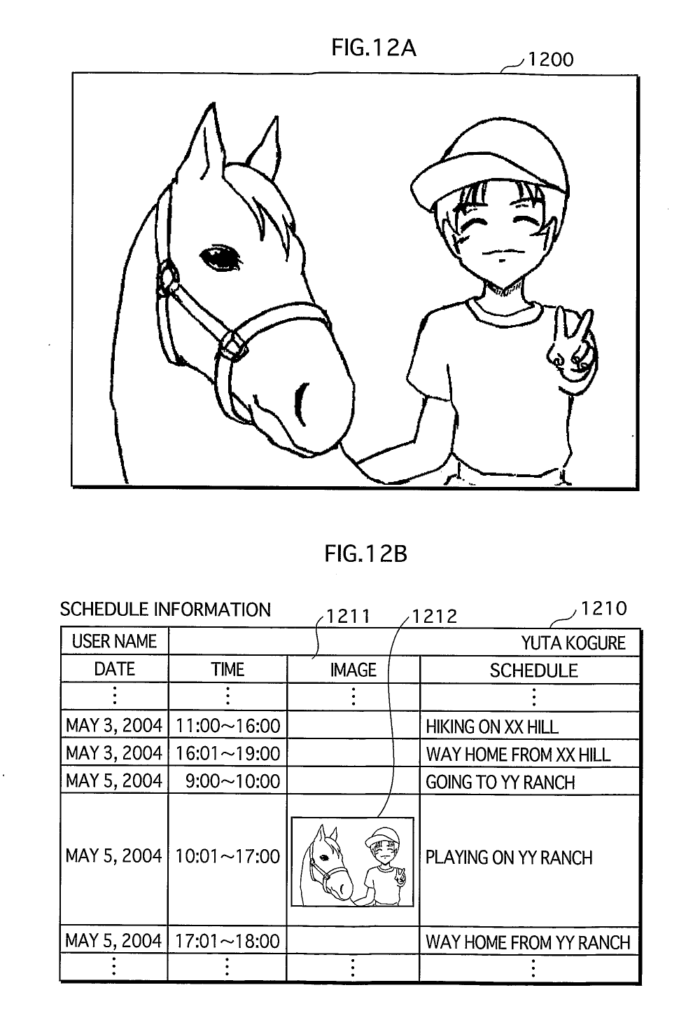

FIG. 12A shows an image 1200 that was shot on YY ranch on May 5, 2004. FIG. 12B shows schedule information 1210 after a title based on the schedule information was put to an image in Embodiment 2. The schedule information 1210 differs from the schedule information 410 shown in FIG. 4 in Embodiment 1 in that it has an image column 1211, and that a reduced image 1212 of the image 1200 is attached to the image column 1211. With this arrangement, it is possible for the user to refer to the schedule information 1210 to determine whether the image is stored in the DVD recorder 100 or in a recording medium such as the DVD 213.

5. Operation of DVD Recorder

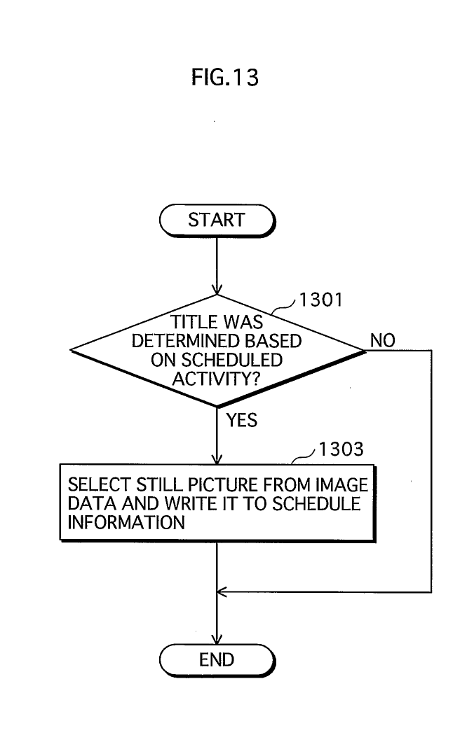

The operation of the DVD recorder 100 for attaching a still picture to the schedule information 1210 after the user determines a title will be described with reference to a flowchart shown in FIG. 13.

First, the DVD recorder 100 judges whether the title was determined based on the schedule information (step S1301). This is achieved by storing information concerning the source of the title in advance, and comparing the title source information with the title information attached to the image. If it is judged positively in step S1301 (YES in step S1301), the DVD recorder 100 extracts a still picture from the image, instructs the object setting unit 226 to write the extracted still picture into the schedule information (step s1303), and ends the process. If it is judged negatively in step S1301 (NO in step S1301), the DVD recorder 100 ends the process.

This will be explained in more detail using a specific example of FIGS. 12A and 12B. In this example, it is presumed that Yuta Kogure played on YY ranch on May 5, 2004, and his image riding on a horse was shot as shown in FIG. 12A. The user sees the GUI 910 and selects “May 5, 2004 Playing on YY Ranch” as the title of the image. This means that the user selects a title that was generated based on the schedule information. Accordingly, the DVD recorder 100 instructs the schedule information storage unit 225 to extract a still picture from the image, generate a reduced image of the still picture, and write the reduced image 1212 to the schedule information for Yuta Kogure as shown in FIG. 12B. This completes the process.

<Supplemental Notes>

Up to now, a recording apparatus for supporting title creation has been explained based on its embodiments. However, not limited to the embodiments, the present invention may be modified variously. The following are some examples of such modifications.

(1) In the above embodiments, the DVD recorder 100 is used as the recording apparatus. However, any apparatus may be used instead in so far as the apparatus can record and reproduce images. For example, a video recorder, a BD (Blu-ray Disc) recorder, or a video camera may be used as the recording apparatus.

(2) In the above embodiments, the recording apparatus stores the personal information 231 and the schedule information 232, and retrieves title candidates from the schedule information 232 and the event information 233. However, the recording apparatus may not store the personal information 231 and the schedule information 232, receive information concerning the age or sex of the object, and retrieve title candidates only from the event information 233 based on the received information.

(3) In the above embodiments, it is presumed that the object of image shooting is a person. However, not limited to a person, the object of image shooting may be any other things including living creatures like animals and sceneries. In such a case, the recording apparatus may store information related to the object, and retrieve title candidates for the object-related information.

(4) Each functional unit constituting the recording apparatus for supporting title creation may be achieved as part or all of an LSI (Large Scale Integration), a VLSI (Very Large Scale Integration) or the like, maybe achieved in a plurality of LSIs, or may be achieved as a combination of one or more LSIs and other circuits.

(5) In the above embodiments, a title candidate selected by the user is written into the image data as it is. However, the title may be edited by the user using the remote controller 130.

(6) In the above embodiments, a title candidate may be composed of an image shooting date/time and a scheduled activity or an event name. However, certain personal information concerning the person related to the image may be attached to the title candidate. For example, a title candidate “May 5, 2004 Boy's Festival” is shown in FIG. 9. This may be displayed as “May 5, 2004 Boy's Festival Yuta Kogure (5 years old)”, which is achieved by extracting the name and the date of birth of the person from the personal information 231, calculating the age of the person at the time of the image shooting by subtracting the date of birth from the shooting date/time, and attaching the name and the age of the person to the title candidate. Such an arrangement enables the user, when seeing the title later, to recognize the main character of the image and the age of the main character at the time when the image was shot.

### INDUSTRIAL APPLICABILITY

The recording apparatus of the present invention for supporting the user's title creation for an image shot by a DV camera or the like can be loaded in a DVD recorder.

1. A recording apparatus for supporting titling an acquired image and recording the acquired image and a title thereof, comprising:
a storage unit prestoring therein title candidates for images and, in correspondence therewith, information concerning time and objects of shooting;
a shooting time acquiring unit operable to acquire information of a shooting time of the acquired image;
an object information acquiring unit operable to acquire information of an object in the acquired image;
a retrieving unit operable to retrieve a title candidate among the prestored title candidates that matches the acquired shooting time information and object information; and
a presentation unit operable to present character sequences containing the retrieved title candidate, to a user.

2. The recording apparatus of claim 1, wherein
said storage unit prestores therein schedule information indicating scheduled activities of persons, together with date/times respectively in correspondence with the scheduled activities,
the title candidates are the scheduled activities indicated in the schedule information,
said retrieving unit detects a person from the object information acquired by said object information acquiring unit, and retrieves a scheduled activity of the detected person from the prestored schedule information, and
said presentation unit presents character sequences containing the retrieved scheduled activity.

3. The recording apparatus of claim 2 further comprising
a personal information storage unit operable to prestore therein personal information concerning the persons, including indication of sex of the persons, wherein
some of the title candidates include names of general yearly events,
said storage unit prestores therein information concerning sex and age of objects for general yearly events, each piece of the information corresponding to an event name,
said retrieving unit detects a person from the object information acquired by said object information acquiring unit, and reads a piece of personal information corresponding to the detected person, from said personal information storage unit, and retrieves an event name that matches the read piece of personal information, and
said presentation unit presents character sequences containing the retrieved event name.

4. The recording apparatus of claim 3, wherein
said personal information storage unit further prestores therein information concerning age of the persons.

5. The recording apparatus of claim 4, wherein said presentation unit presents a list of title candidates in an order of (i) a title candidate being a scheduled activity that matches the acquired shooting time information and object information and (ii) one or more title candidates corresponding to one or more events in an order of a highest to a lowest correspondence level.

6. The recording apparatus of claim 3, wherein
said presentation unit presents title candidates that contain a name or an age or both the name and age that are extracted from the personal information concerning the object in the acquired image for which said object information acquiring unit has acquired the information.

7. The recording apparatus of claim 1 further comprising:
a title determining unit operable to determine the title of the acquired image based on a user input selecting one among the presented character sequences; and
an image storage unit operable to store the acquired image and the determined title with indication of a correspondence between thereof.

8. The recording apparatus of claim 2 further comprising:
a title determining unit operable to determine the title of the acquired image based on the presented character sequences and a user input; and
an image storage unit operable to store the acquired image and the determined title with indication of a correspondence between thereof.

9. The recording apparatus of claim 8 further comprising
a still picture attaching unit operable, if the title determining unit determines one among the character sequences containing the retrieved scheduled activity as the title, to extract a still picture from the acquired image and attach the extracted still picture to the schedule information in correspondence with the retrieved scheduled activity.

10. A title presentation method for presenting candidates for a title of an acquired image, said title presentation method comprising:
prestoring candidates for titles of images and, in correspondence therewith, information concerning time and objects of shooting;
acquiring information of a shooting time of the acquired image;
acquiring information of an object in the acquired image;
retrieving a title candidate among the prestored title candidates that matches the acquired shooting time information and object information; and
presenting character sequences containing the retrieved title candidate, for a user to determine a title of the acquired image.

11. A title presentation program for execution on a computer for presenting candidates for a title of an acquired image, said title presentation program comprising:
program code operable to cause the computer to prestore candidates for titles of images and, in correspondence therewith, information concerning time and objects of shooting;
program code operable to cause the computer to acquire information of a shooting time of the acquired image;
program code operable to cause the computer to acquire information of an object in the acquired image;
program code operable to cause the computer to retrieve a title candidate among the prestored title candidates that matches the acquired shooting time information and object information; and
program code operable to cause the computer to present character sequences containing the retrieved title candidate, for a user to determine a title of the acquired image.

12. An integrated circuit for putting a title to an acquired image and recording the acquired image with the title, comprising:
a storage unit operable to prestore therein candidates for titles of images and, in correspondence therewith, information concerning time and objects of shooting;
a shooting time acquiring unit operable to acquire information of a shooting time of the acquired image;
an object information acquiring unit operable to acquire information of an object in the acquired image;
a retrieving unit operable to retrieve a title candidate among the prestored title candidates that matches the acquired shooting time information and object information;
a presentation unit operable to present character sequences containing the retrieved title candidate, for a user to determine a title of the acquired image; and
an image data storage unit operable to store therein a title determined by the user, together with data concerning the acquired image.
